(19) United States
(12) Patent Application Publication
(10) Pub. No.: US 2006/0130782 A1
(43) Pub. Date: Jun. 22, 2006

(54) Engine

(76) Inventor: David V. Boland, Mount Pleasant, SC (US)

Correspondence Address: B. Craig Killough;Barnwell Whaley Patterson & Helms, LLC, P.O. Drawer H, Charleston, SC, 29402-0197, US

(21) Appl. No.: 11/206,936

(22) Filed: Aug. 18, 2005

Related U.S. Application Data
(60) Provisional application No. 60/637,292, filed on Dec. 17, 2004.

(51) Int. Cl. F02B 75/18

(52) U.S. Cl. 123/55.2

(57) ABSTRACT

An engine has a pivotally mounted tie member that connects a piston rod to a second piston rod. Each piston rod is connected to multiple pistons.

### SUMMARY OF THE INVENTION

This invention is an engine. The engine has a pivotally mounted tie member that connects a piston rod to a second piston rod.

### DESCRIPTION OF THE DRAWINGS

FIG. 1 is a sectioned view of an engine according to a preferred embodiment of the present invention.

FIG. 2 is a sectioned view of the engine of FIG. 1.

FIG. 3 is a sectioned view of the engine taken essentially along line 3-3 of FIG. 1.

FIG. 4 is a sectioned view of the engine taken essentially along line 4-4 of FIG. 1.

FIG. 5 is a sectioned view of another engine according to a preferred embodiment of the present invention.

FIG. 6A is a sectioned view of the engine of FIG. 5.

FIG. 6B is the engine of FIG. 6A with the pistons on different cycles.

FIG. 7 is an additional sectioned view of the engine of FIG. 5.

### DETAILED DESCRIPTION OF PREFERRED EMBODIMENTS

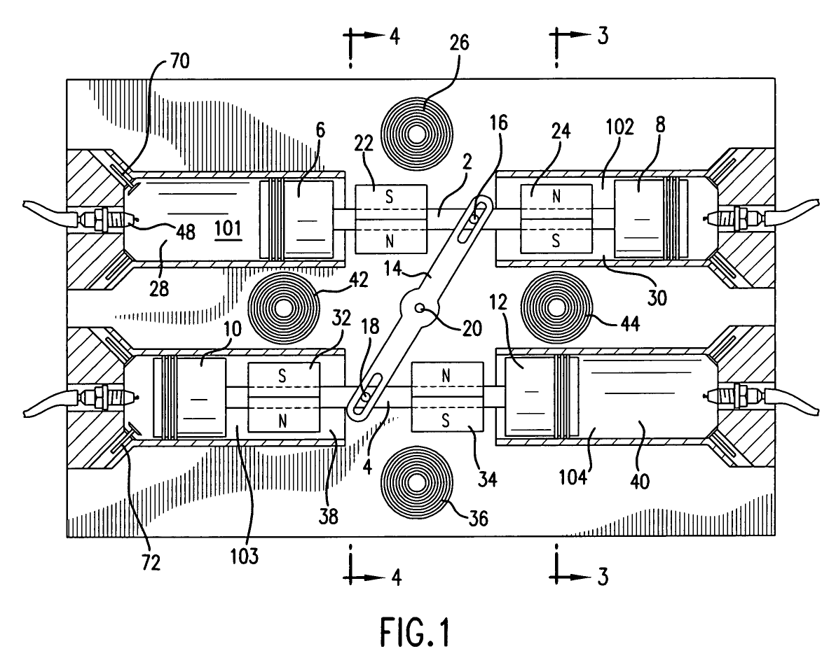

In a preferred embodiment, the engine of the present invention is an internal combustion engine having pistons that traverse cylinders. A first cylinder 101 has a piston 6 and a second cylinder 102 has a piston 8. A third cylinder 103 has a piston 10 and a fourth cylinder 102 has a piston 12. A rod 2 extends from the pistons 6,8, and another rod 4 extends from other pistons 10,12. FIG. 1. The rods oscillate as the pistons are powered within the cylinders, and are generally parallel to each other. The rods are connected to each other by a tie member 14. The tie member is pivotally attached to each rod, and is also pivotally mounted to the engine.

The engine in one embodiment has a first opposed piston 6 and a second opposed piston 8. Each piston traverses its own cylinder. Each piston is connected to another piston by a rod, and in this embodiment of the invention, the rod is rigidly mounted to each piston, that is, the piston does not pivot relative to the rod, although the rod could be mounted to the piston by a wrist pin that would permit pivoting when the device is disassembled. Piston 6, piston 8 and rod 2, form a piston and rod assembly. The piston and rod assembly travel linearly within the two opposing cylinders 101,102 as shown in the drawing figures.

The engine according to the embodiment of FIG. 1 has a third opposed cylinder 103 and fourth opposed cylinder 104. Piston 10, piston 12 and rod 4, with their corresponding cylinders, form the second piston and cylinder assembly. The piston and rod assembly travel linearly within the two opposing cylinders 103,104 as shown in the drawing figures. The first and second piston and rod assembly traverse their respective cylinders so that the first piston and rod assembly travels generally parallel to the second piston and rod assembly. The engine shown in the drawing figures according to this embodiment may be characterized as horizontally opposed.

In the embodiment of FIG. 1, the rod 4 that connects piston 10 and piston 12 of the second piston and cylinder assembly may be rigid, although the rod could be mounted to the piston by a wrist pin that would permit pivoting when the device is disassembled. The first piston assembly and second piston assembly yield an opposed four cylinder piston engine, having two rods that oscillate substantially parallel to each other.

The rod of the first piston and cylinder assembly and the rod of the second and cylinder assembly are connected by a tie member 14. The tie member is pivotally mounted to the first rod and pivotally mounted to the second rod, and a slot may be formed in the tie member near the mounting points 16,18. The tie member is also pivotally mounted 20 to the engine case. The “engine case” as used herein could be any part of the engine that is stationary relative to the pistons and rods, and could be the engine block 21. The purpose of the pivotal mounting is to hold the tie member in position relative to the rods and about a point 20 of the tie member. The tie member will not rotate relative to the pivot point more than 180 degrees, and in the embodiment shown in FIG. 1, the tie member rotates only about 90 degrees. In a preferred embodiment, the assembly of two pistons and one rod travel substantially in a straight line. The pistons do not materially pivot or rotate relative to the rod, even though the pistons could be pivotally mounted to the rod, or the pistons could be mounted to the rod so that the are not capable of pivoting or rotating.

In the embodiment of the invention shown in FIG. 1 the engine is used to generate electricity. A magnet 22 is mounted on rod 6 on one side of the tie member pivot point 16, and another magnet 24 is mounted on the rod 6 opposite magnet 22. A coil 26 is positioned between the first cylinder 28 and the second cylinder 30 in a preferred embodiment. Magnet 24 has a polarity) that is near the coil 26, and the magnet 22 has an opposite polarity near the same coil. As shown, magnet 22 has a south polarity near coil 26, while magnet 24 has a north polarity near coil 26.

A third magnet 32 and fourth magnet 34 are on rod 4 each mounted opposite the pivot point of the rod 4 to the tie member. Again, magnets have opposite polarity near the same coil. A coil 36 is positioned between each cylinder 38,40 as shown. Additional coils 42,44 are positioned between and beside the cylinders.

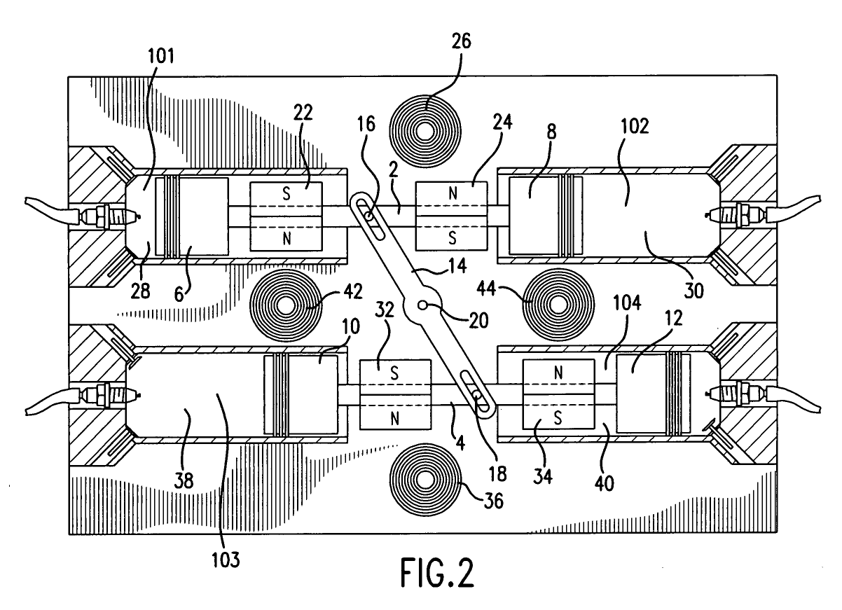

As shown in FIG. 1, piston 6 is on an intake stroke, while piston 8 is on a compression stroke. Piston 10 is on an exhaust stroke, while piston 12 is on a power stroke. Moving to FIG. 2, piston 6 is on a compression stroke, piston 8 is on a power stroke, piston 12 is on an exhaust stroke, and piston 10 is on an intake stroke. However, the timing or arrangement of the various cycles could be varied to achieve optimum efficiency, which is within the purview of one skilled in the art. While the preferred embodiment is a four stroke engine, the engine could be designed as a two stroke engine.

The engine could be an internal combustion engine or an external combustion engine. Fuel, such as gasoline, may be provided through intake valves 70 as shown in the drawing figures, and ignited by spark plugs 48. After combustion, fuel exits through the exhaust valves 72. Carburetion of the fuel may be provided by known means, including carburetors or fuel injection. The device could be powered by steam, for example, as an external combustion engine

Movement of the magnets attached to the rods as they oscillate past the coils generates an electrical field. The device allows the opposite polarity of the magnets on the rod to move past the coils as shown for the purpose of generating electricity. Additional, or other, coil arrangements may be used. The addition of more piston and cylinder assemblies permits the addition of more coils and increased generating capacity.

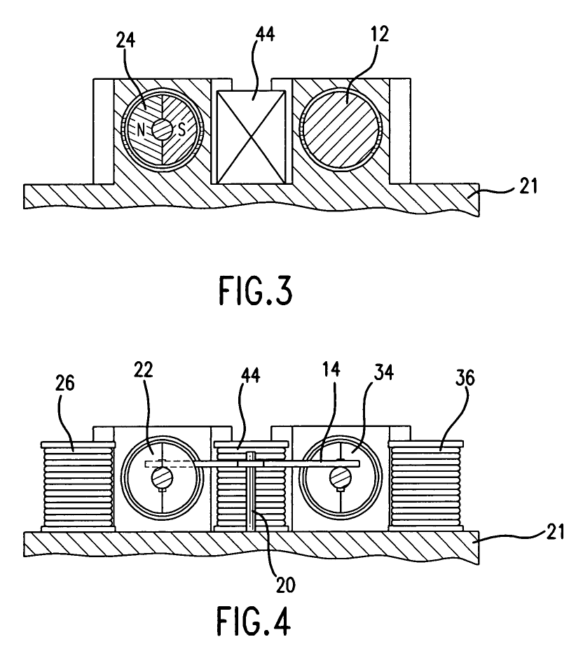

FIG. 3 shows a sectioned view with the position of magnet 24 and the piston 12 relative to the coil 44.

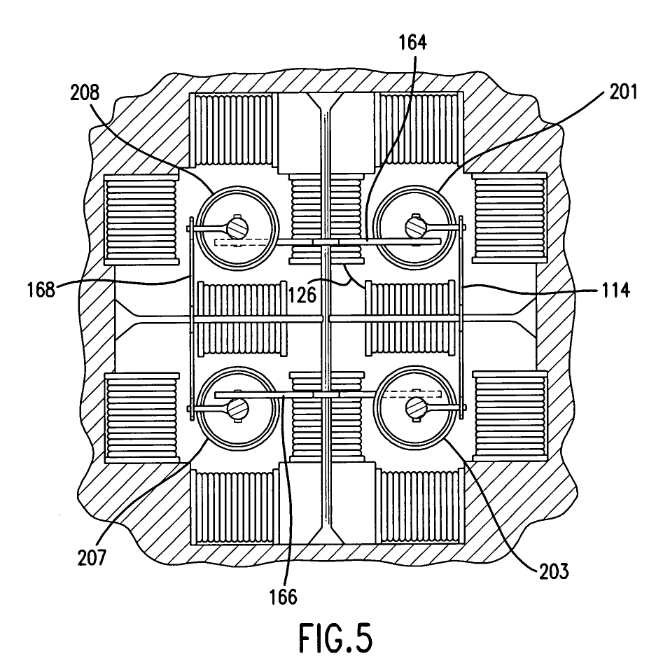

FIG. 4 shows a side view of the position of a magnet of the first piston and cylinder assembly and a magnet of the second piston and cylinder assembly relative to the coils. The pivot 20 is mounted to the engine block 21 and the tie member 14. The tie member 14 assists with timing of the first piston and cylinder assembly relative to the second piston and cylinder assembly, and allows the device to be more than a two cylinder engine.

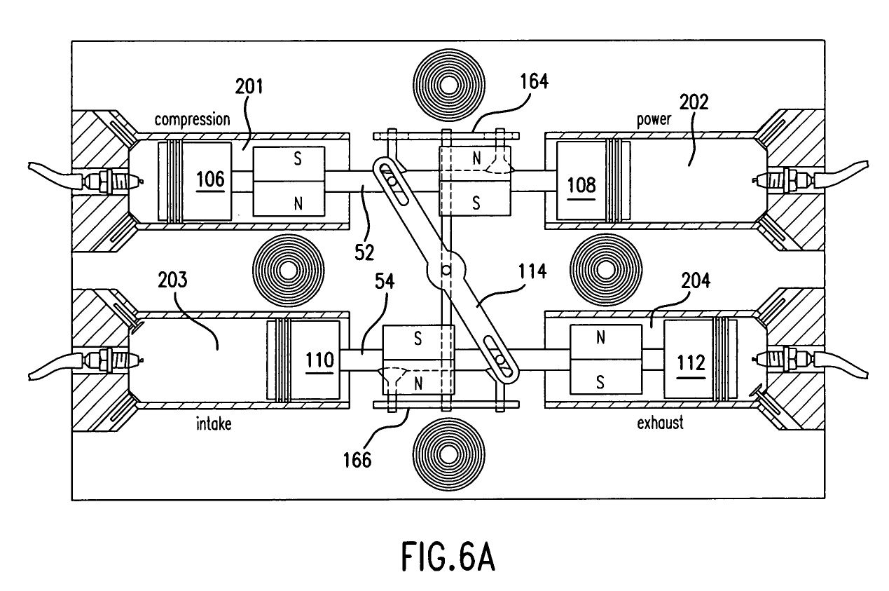

An eight cylinder engine is shown in the embodiment of the device according to FIG. 5 through FIG. 7. The additional cylinders provide additional power generation. Through the use of additional tie members, four or more piston and cylinder assemblies, like the first piston cylinder assembly and second piston cylinder assembly, are available.

Two tie members are attached to a single pivot point on a rod to connect a third piston and cylinder assembly. As shown in FIG. 5, the cylinders are stacked to create eight pistons and cylinders with tie members or linkages between the piston and cylinder assemblies. The pistons and cylinder may be further stacked to create 12 or 16 or more piston and cylinder combinations. The tie member between a top set of four pistons and a bottom set of four pistons connects at the pivot point of the tie member, with the tie member perpendicular to the linkage as shown in FIG. 1.

FIG. 5 shows an embodiment of the engine having a total of 8 pistons and cylinders and 4 connecting rods. Four cylinders, represented by 201, 203, 205 and 207 are shown in this Figure. The pistons, cylinders and rods are arranged so that the engine of this embodiment is substantially a square configuration when viewed as in FIG. 5, with the rod and piston combinations being side by side, and over and above each other. In this embodiment, each upper piston rod is connected to the piston rod immediately below it, and each piston rod is connected by means of a linkage to the piston rod beside it. Accordingly, each connecting rod is ultimately connected to every other connecting rod.

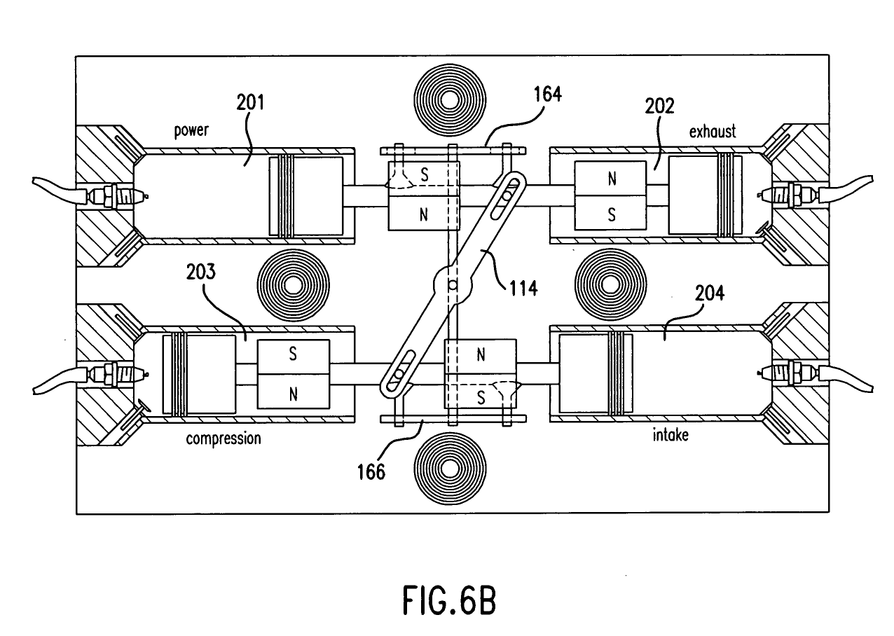

FIG. 6A shows the tie member 114 pivotally mounted to an upper connecting rod 52 and a lower connecting rod 54. The tie member is also pivotally mounted to the engine case or block, as shown in the embodiment of the engine in FIG. 1. However, in this embodiment, the connecting rod is also connected to the connecting rod adjacent to it, or above or below it, by an additional tie member 164,166. As shown in FIG. 6A, each connecting rod is connected to two tie members, and each tie member is connected to two connecting rods.

In FIG. 6A, cylinders one (1) through four (4) of the eight cylinder engine are shown and numbered 201, 202, 203 and 204, respectively. The piston 106 is on a compression stroke, piston 108 is on a power stroke, piston 110 is on an intake stroke, and piston 112 is on an exhaust stroke.

FIG. 6B shows the reciprocating engine of FIG. 6A. Cylinders one (1) through four (4) of the eight cylinder engine are again shown. Piston 106 is on a power stroke, the piston 108 is on an exhaust stroke, piston 110 is on a compression stroke, and piston 112 is on an intake stroke. The tie members have pivoted from the positions of FIG. 6A as the engine operates.

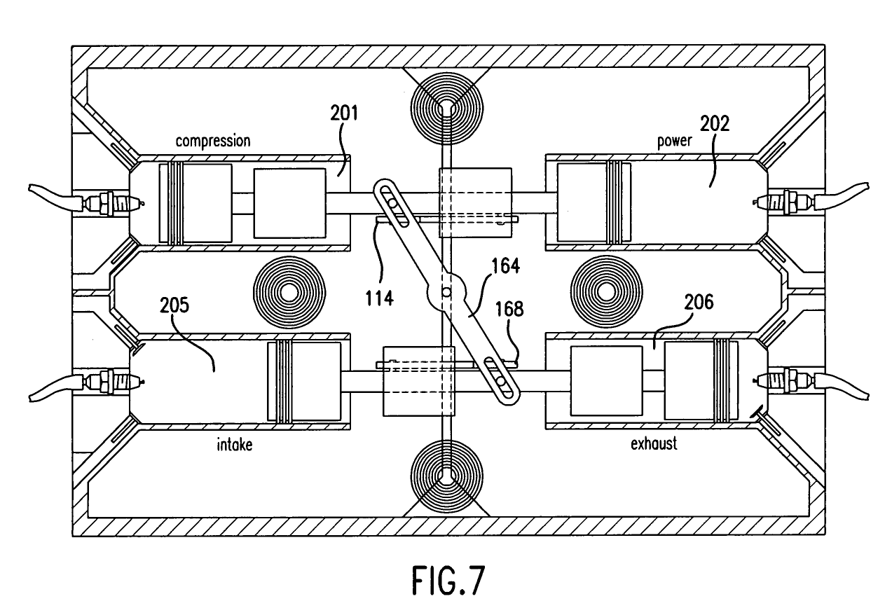

FIG. 7 shows the reciprocating engine of FIG. 6A, with the engine in the same cycle as shown in FIG. 6A. Cylinders one (1), two (2), five (5) and six (6) of the eight cylinder engine are shown and numbered 201, 202, 205 and 206, respectively.

The piston 106 of cylinder 201 is on a power stroke, the piston 108 of cylinder 202 is on an exhaust stroke, the piston of cylinder 205 is on an intake stroke, and the piston of cylinder 206 is on an exhaust stroke. Tie members 114, 164 and 168 are shown as connecting appropriate connecting rods.

The timing or arrangement of the various cycles could be varied to achieve optimum efficiency, which is within the purview of one skilled in the art. While the preferred embodiment is a four stroke engine, the engine could be designed as a two stroke engine.

The eight cylinder embodiment shown in the drawing figures again uses magnets and coils 126 to induce the generation of electricity. Movement of the magnets attached to the rods as they travel past the coils generates an electrical field.

What is claimed is:

1. An engine, comprising:
a) a first piston and cylinder assembly, said first piston and cylinder assembly comprising at least one cylinder, at least one piston that traverses said at least one cylinder, and a piston rod extending from said at least one piston of said first piston and cylinder assembly;
b) a second piston and cylinder assembly, said second piston and cylinder assembly comprising at least one cylinder, at least one piston that traverses said at least one cylinder, and a piston rod extending from said at least one piston of said second piston and cylinder assembly; and
c) a tie member that is pivotally mounted to said piston rod of said first piston and cylinder assembly and is pivotally mounted to said piston rod of said second piston and cylinder assembly, and said tie member is pivotally mounted to a case of said engine, wherein said tie member does not rotate more than 180° from a point where said tie member is pivotally mounted to said case of said engine.

2. An engine as described in claim 1, further comprising a magnet that is attached to said piston rod of said first piston and cylinder assembly.

3. An engine as described in claim 1, further comprising a first magnet, a second magnet and at least one coil, wherein said first piston and cylinder assembly causes said first magnet and said second magnet to move relative to said at least one coil.

4. An engine as described in claim 3, wherein a polarity of said first magnet is closest to one of said at least one coil and a same polarity of said second magnet is closest to another of said at least one coil.

5. An engine as described in claim 3, further comprising a first magnet, a second magnet and at least one additional coil, wherein said first piston and cylinder assembly causes said first magnet and said second magnet to move relative to said at least one additional coil, and wherein at least one additional coil is positioned opposite said piston rod from said at least one coil.

6. An engine, comprising:
a) a first piston and cylinder assembly, said first piston and cylinder assembly comprising a first piston, a second piston opposed to said first piston, and a piston rod that connects said first piston to said second piston;
b) a second piston and cylinder assembly, said second piston and cylinder assembly comprising a first piston, a second piston opposed to said first piston, and a piston rod that connects said first piston to said second piston of said second piston and cylinder assembly; and
c) a tie member that is pivotally mounted to said piston rod of said first piston and cylinder assembly and is pivotally mounted to said piston rod of said second piston and cylinder assembly, and is pivotally mounted to a case of said engine, wherein said tie member does not rotate more than 180° from a point where said tie member is pivotally mounted to said case of said engine.

7. An engine as described in claim 6, further comprising a magnet that is attached to said piston rod of said first piston and cylinder assembly.

8. An engine as described in claim 7, further comprising a first magnet, a second magnet and at least one coil, wherein said first piston and cylinder assembly causes said first magnet and said second magnet to move relative to said at least one coil.

9. An engine as described in claim 8, wherein a polarity of said first magnet is closest to one said at least one coil and a same polarity of said second magnet is closest to another said at least one coil.

10. An engine as described in claim 8, further comprising a first magnet, a second magnet and at least one additional coil, wherein said first piston and cylinder assembly causes said first magnet and said second magnet to move relative to said at least one additional coil, and wherein at least one additional coil is positioned opposite said piston rod from said at least one coil.

11. An engine as described in claim 1, further comprising a third piston and cylinder assembly, said third piston and cylinder assembly comprising at least one cylinder, at least one piston that traverses said at least one cylinder, and a piston rod extending from said at least one piston of said third piston and cylinder assembly;
a fourth piston and cylinder assembly, said fourth piston and cylinder assembly comprising at least one cylinder, at least one piston that traverses said at least one cylinder, and a piston rod extending from said at least one piston of said fourth piston and cylinder assembly.

12. An engine as described in claim 11, further comprising a tie member that is pivotally mounted to said piston rod of said third piston and cylinder assembly and is pivotally mounted to said piston rod of said fourth piston and cylinder assembly;
a tie member that is pivotally mounted to said piston rod of said second piston and cylinder assembly and is pivotally mounted to said piston rod of said fourth piston and cylinder assembly; and
a tie member that is pivotally mounted to said piston rod of said first piston and cylinder assembly and is pivotally mounted to said piston rod of said third piston and cylinder assembly.

13. An engine as described in claim 6, further comprising
a third piston and cylinder assembly, said third piston and cylinder assembly comprising a first piston, a second piston opposed to said first piston, and a piston rod that connects said first piston to said second piston;
a fourth piston and cylinder assembly, said fourth piston and cylinder assembly comprising a first piston, a second piston opposed to said first piston, and a piston rod that connects said first piston of said second piston of said fourth piston and cylinder assembly.

14. An engine as described in claim 13, further comprising
a tie member that is pivotally mounted to said piston rod of said third piston and cylinder assembly and is pivotally mounted to said piston rod of said fourth piston and cylinder assembly;
a tie member that is pivotally mounted to said piston rod of said second piston and cylinder assembly and is pivotally mounted to said piston rod of said fourth piston and cylinder assembly; and
a tie member that is pivotally mounted to said piston rod of said first piston and cylinder assembly and is pivotally mounted to said piston rod of said third piston and cylinder assembly.
